(19) United States
(12) Patent Application Publication
(10) Pub. No.: US 2004/0161240 A1
(43) Pub. Date: Aug. 19, 2004

(54) Module having two bi-directional optical transceivers

(76) Inventor: Andreas Weber, Los Altos, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/782,565

(22) Filed: Feb. 19, 2004

Related U.S. Application Data
(60) Provisional application No. 60/448,361, filed on Feb. 19, 2003.

(51) Int. Cl. H04B 10/00; G11B 7/00

(52) U.S. Cl. 398/139

(57) ABSTRACT

Bi-directional communications modules are configured for propagating transmission and reception of optical data along each of dual optical cables. The modules generally include: a first transmitter configured for transmitting data on a first wavelength channel onto a first optical fiber; a first receiver configured for receiving data on a second wavelength channel from the first optical fiber; a second transmitter configured for transmitting data on the second wavelength channel onto a second optical fiber; and a second receiver configured for receiving data on the first wavelength channel from the second optical fiber. By changing the use of the dual optical cables from unidirectional traffic to bi-directional traffic, the modules thereby double the data transmission capacity of the cables without changing the size of the cables or transceiver modules or requiring the installation of new cables.

### CROSS-REFERENCE TO RELATED APPLICATIONS

This application claims the benefit of U.S. Provisional Application No. 60/448,361, filed Feb. 19, 2003.

### BACKGROUND OF THE INVENTION

1. The Field of the Invention

The present invention relates generally to high speed data transmission systems. More particularly, embodiments of the invention relate to an integrated device for improving optical interconnect density with existing cable infrastructure. In one embodiment of the invention the integrated devices provide for bi-directional communications traffic on each of dual optical cables.

2. The Relevant Technology

In the field of data transmission, one method of efficiently transporting data is through the use of fiber optics. Typically, data transmission via fiber optics is implemented by way of an optical transmitter, such as a light emitting diode or laser, while data reception is generally implemented by way of an optical receiver, such as a photodiode. Light signals allow for extremely high transmission rates and very high bandwidth capabilities. Also, light signals are resistant to electromagnetic interferences that would otherwise interfere with electrical signals. Light signals are more secure because they do not allow portions of the signal to escape from the fiber optic cable as can occur with electrical signals in wire-based systems. Light also can be conducted over greater distances without the signal loss typically associated with electrical signals on copper wire.

One method of achieving bi-directional communication is through the use of two fiber optic cables. A first cable can be used to transmit data from a first communications device to a second communications device and the second cable can be used for transmitting data from the second communications device to the first communications device. Such a configuration is depicted in FIG. 1, which depicts a standard small form factor pluggable (SFP) connector configuration 100, in which “R” designates a receiver and “T” designates a transmitter.

Connector configuration 100 includes first communications module 102 and second communications module 104 connected by first cable 106 and second cable 108. A transmitter 110 in first communications module 102 is connected via first cable 106 to receiver 112 in second communications module 104. Similarly, transmitter 114 in second communications module 104 is connected via second cable 108 to receiver 116 in first communications module 102. Thus, data is transmitted between first communications module 102 and second communications module 104 unidirectionally on each of cables 106, 108 from transmitters 110, 114 to receivers 112, 116.

Nevertheless, it is often desirable to limit the number of fiber optic cables between two communication points to save on material costs and installation. The link density is also limited by the amount of fiber optic connectors that can be fitted on the face plate of a switch box or another host device that contains an array of transceivers. This need has led to the development of bi-directional (BiDi) systems that limit the number of cables (and connectors) by both sending and receiving data on the same fiber optic cable, which is possible because of the directional nature of an optical signal that is propagated along a fiber optic cable. Generally, achieving bi-directional communication on a single fiber optic cable is done through the use of circulators or beam splitters.

A conventional BiDi transceiver module configuration 200 is depicted in FIG. 2. This method of bi-directional communication along a single fiber-optic cable involves the use of lasers with different wavelengths. Commonly a 1550 nanometer distributed feedback (DFB) laser is used to propagate an optical signal in one direction and a 1310 nanometer Fabry Perot laser (FP) is used to propagate the optical signal in the opposite direction. One drawback with this configuration is that it requires two types of transceivers that are complementary, with different transceivers being used at the two communications devices that are engaging in the bi-directional communication. For example, one of the two communications devices must have a transceiver with a 1550 nanometer transmitter and a 1310 nanometer receiver. In contrast, the other of the two communications devices must have a complementary transceiver having a 1310 nanometer transmitter and a 1550 nanometer receiver.

This BiDi configuration 200 allows bi-directional data transmission between first module 202 and second module 204 via a single cable 206. In this configuration, each of the first and second modules has a transmitter 208, 210 for transmitting at a distinct wavelength from the other, so that first module 202 transmits at a first wavelength (e.g. 1550 nanometers) and the second module 204 transmits at a second wavelength (e.g. 1310 nanometers). Similarly, first module 202 has a first receiver 212 for receiving signals propagated at the second wavelength and the second module 204 has a second receiver 214 for receiving signals propagated at the first wavelength. First and second modules 202, 204 as depicted also contain beam splitters 216, 218 for separating incoming signals propagated at one wavelength from outgoing wavelengths signals propagated at a different wavelength. The first and second modules are structurally distinct and so they must be carefully paired so that each can receive the proper signal transmitted by the opposing module.

Still, the telecommunications industry has a continuous need to both increase data transmission rates and to migrate from larger to smaller devices without sacrificing data transmission rates. For example, gigabit interface connectors (GBIC) are being replaced by small form factor connectors, often small form factor pluggable (SFP) connectors. GBIC converters include an interface module which converts the light stream from a fiber channel cable into electronic signals for use by a network interface card. SFP connectors provide the same functionality as a regular GBIC connector but in a smaller and denser physical size. Nevertheless, because of the large volume of legacy cable and connector systems that are already in use, the need for smaller and faster systems is tempered by the desire to avoid replacing existing cables and other legacy devices.

One recent approach utilizes existing LC cables, which have paired fibers, each of which conventionally transmits optical data unidirectionally. This approach uses each cable for bi-directional (BiDi) data transmission and does not require two types of modules since both transceivers in the module are identical. This transceiver module requires a total of four lasers and four photodetectors, or one for each of two distinct wavelengths that are transmitted in opposite directions in each of the two cables. The modules require a complex negotiation procedure by which opposing transceiver modules at either end of an optical cable communicate to determine the wavelengths that each will send and each will receive.

Another BiDi approach to increasing data transmission capacity on existing dual cable systems transmits signals in opposing directions along a single wavelength on each optical cable and thus requires only one transmitter and one receiver at each end of each optical cable. However, the use of identical wavelengths results in a problematic optical reflection that can be caused by fiber interconnects so that a receiver sees the data transmissions from the transmitters at both ends of the optical cable rather than just the intended transmitter at the opposite end of the optical cable. This system therefore requires the use of complex echo cancellation devices to remove the reflected data transmissions that are not intended to reach the receiver.

Accordingly, there is a continuing need for simpler and faster transceiver modules to improve data transmission on existing dual cable transmissions lines, such as small form factor cables.

### BRIEF SUMMARY OF THE INVENTION

The present invention relates to optical modules that provide bi-directional communications on dual optical cables. In conventional optical systems, communications traffic travels unidirectionally on each of the dual optical fibers. In contrast, the present modules advantageously allow each of the dual optical cables that connect with the transceiver modules to carry bi-directional optical signals, thereby doubling the data transmission capacity of the cables without changing the size of the cables or transceiver modules. One advantage of the modules is that identical modules can be used at each terminus of the dual cables without the need for auto-negotiation or echo cancellation devices or methods.

Accordingly, a first embodiment of the invention is a bi-directional communications module configured for propagating transmission and reception of optical data along dual optical cables. The module includes: a first transmitter configured for transmitting data on a first wavelength channel onto a first optical fiber; a first receiver configured for receiving data on a second wavelength channel from a first optical fiber; a second transmitter configured for transmitting data on the second wavelength channel on a second optical fiber; and a second receiver configured for receiving data on the first wavelength channel from the second optical fiber. In one embodiment of the invention each of the first transmitter and the first receiver are part of a first transceiver and each of the second transmitter and the second receiver are part of a second transceiver.

Another example embodiment of the invention is an optical system for propagating transmission and reception of optical data along dual optical cables. The system includes a first bi-directional communications module, a second bi-directional communications module, and first and second optical fibers. The first bi-directional communications module includes first and second bi-directional transceivers. The first bi-directional transceiver includes a first transmitter configured for transmitting data along a first wavelength channel and a first receiver configured for receiving data along a second wavelength channel. The second bi-directional transceiver includes a second transmitter configured for transmitting data along the second wavelength channel and a second receiver configured for receiving data along the first wavelength channel.

Similarly, the second bi-directional communications module includes a third bi-directional transceiver and a fourth bi-directional transceiver. The third bi-directional transceiver includes a third transmitter configured for transmitting data along a first wavelength channel and a third receiver configured for receiving data along a second wavelength channel. The fourth bi-directional transceiver includes a fourth transmitter configured for transmitting data along the second wavelength channel and a fourth receiver configured for receiving data along the first wavelength channel.

The first optical fiber is in optical communication with each of the first transceiver and the fourth transceiver. The second optical fiber is in optical communication with each of the second transceiver and the third transceiver.

Yet another example embodiment of the invention is a method for propagating transmission and reception of optical data along dual optical cables. The method generally includes: at a first optical module, transmitting a first optical signal over a first wavelength channel down a first optical fiber in a first direction and transmitting a second optical signal over a second wavelength channel down a second optical fiber in the first direction; and at a second optical module, transmitting a third optical signal over the second wavelength channel down the first optical fiber in a second direction and transmitting a fourth optical signal over the first wavelength channel down the second optical fiber in the second direction.

Another example embodiment of the invention is a method for increasing data transmission capacity on an existing optical network including dual optical cables. The method includes generally: providing a legacy optical system that includes first and second optical cables, each of the first and second optical cables including connectors at each terminus of the optical cables; and connecting a first bi-directional communications module on adjacent ends of each of the first and second optical cables and connecting a second bi-directional communications module to the opposing adjacent ends of each of the first and second optical cables. The first bi-directional communications module includes: connectors that are compatible with the connectors on the first and second optical cables; a first transmitter configured for transmitting data on a first wavelength channel onto the first optical cable; a first receiver configured for receiving data on a second wavelength channel from the first optical cable; a second transmitter configured for transmitting data on the second wavelength channel on the second optical cable; and a second receiver configured for receiving data on the first wavelength channel on the second optical cable.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic diagram that illustrates aspects of a bi-directional transceiver module system according to the prior art;

FIG. 2 is a schematic diagram that illustrates aspects of an SFP transceiver module system according to the prior art;

FIG. 3 is a schematic diagram that illustrates aspects of a bi-directional transceiver module for embodiments of the present invention; and

FIG. 4 is a schematic diagram that illustrates aspects of a bi-directional transceiver module for embodiments of the present invention.

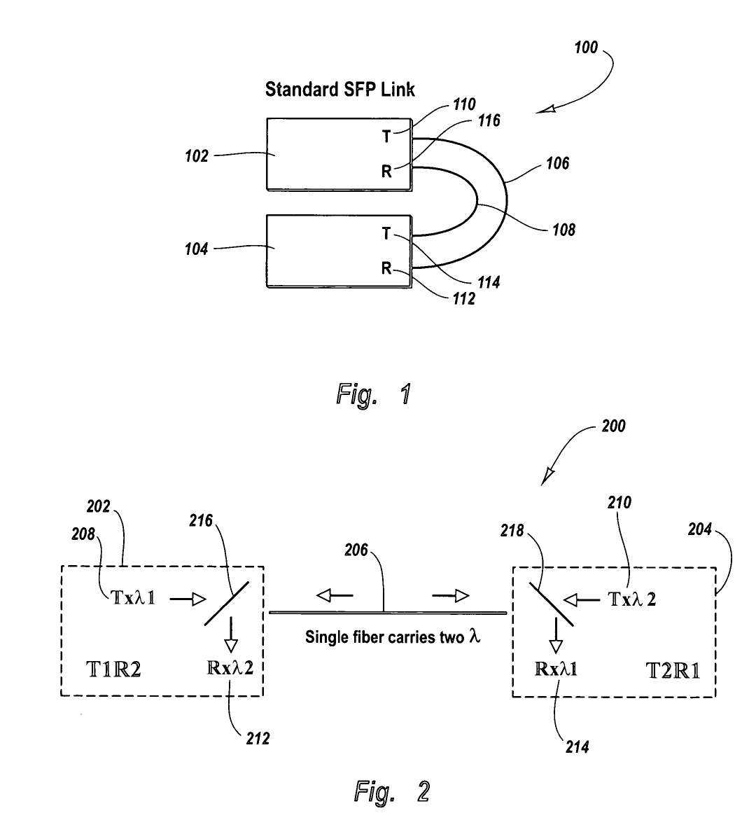

### DETAILED DESCRIPTION OF THE INVENTION

The present invention relates to optical modules that provide bi-directional communications on dual optical cables. In conventional optical systems communications traffic travels unidirectionally on each of the dual optical fibers. In contrast, the present modules advantageously allow each of the dual optical cables that connect with the transceiver modules to carry bi-directional optical signals, thereby doubling the data transmission capacity of the cables without changing the size of the cables or transceiver modules.

One example of a bi-directional optical transceiver that can operate according to exemplary embodiments of the invention is an optical module that has a pair of bi-directional transceivers, each with a transmitter and a receiver. This advantageously allows each of the two optical cables that connect with the optical module to carry bi-directional optical signals, thereby doubling the data transmission capacity of the cables without changing the size of the cables or optical modules. Identical modules can be used at each terminus of the dual cables without the need for auto-negotiation or echo cancellation devices or methods so long as the cables are correctly attached to the modules.

Reference will now be made to the drawings to describe various aspects of exemplary embodiments of the invention. It is to be understood that the drawings are diagrammatic and schematic representations of such exemplary embodiments, and are not limiting of the present invention, nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of optical systems have not been described in particular detail in order to avoid unnecessarily obscuring the present invention.

While the exemplary embodiment of the invention discussed below is well-suited for use in conjunction with a high speed data transmission system conforming to the small form factor pluggable standards (SFP), such operating environment is exemplary only and embodiments of the invention can, more generally, be employed in any of a variety of high speed data transmission systems.

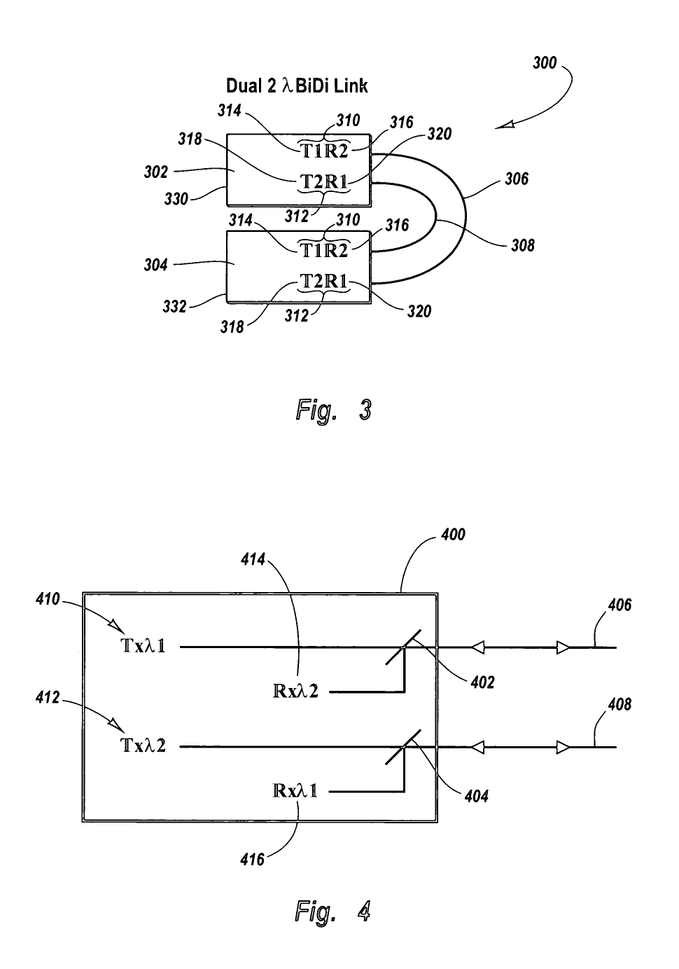

FIG. 3 is a schematic diagram that illustrates aspects of one example of a dual wavelength BiDi link system, designated generally at 300. More particularly, FIG. 3 depicts first bi-directional communications module 302 and second bi-directional communications module 304 connected by first cable 306 and second cable 308. First and second cables 306, 308 can include legacy cables (connected to legacy connectors) so that the exemplary embodiments of the present invention can be implemented without necessitating any change in existing cables and connectors, thereby reducing the implementation costs of this invention.

Although first and second cables 306 and 308 are therefore potentially identical in structure to first cable 106 and second cable 108 from the prior art system depicted in FIG. 1, first and second cables 306 and 308 are utilized differently than they would be used by conventional systems in that they have bi-directional optical data flowing along their lengths rather than the unidirectional flow that is directed through first cable 106 and second cable 108. Thus, the embodiment illustrated in FIG. 3 greatly increases the utilization of the existing fiber optic infrastructure.

First bi-directional communications module 302 and second bi-directional communications module 304 can be identical modules, each having a pair of BiDi subassemblies 310, 312 therein. Each of the BiDi subassemblies 310, 312 is in communication with one end of one of cables 306, 308 and includes a transmitter and receiver pair. For example, subassembly 310 includes transmitter 314 and receiver 316 and subassembly 312 includes transmitter 318 and receiver 320. Both receivers 316, 320 can include a photodetector such as, by way of example only, a Longwave PIN diode manufactured by Sensors Unlimited, part number 1008696. Transmitter 314 of subassembly 310 in first BiDi module 302, can be, by way of example only, a 1550 nanometer distributed feedback (DFB) laser, thereby by providing a first wavelength data transmission that is propagated through first cable 306 and received by receiver 320 of subassembly 312 in second bi-directional communications module 304. Transmitter 318 of subassembly 312 in second BiDi module 304 can be, also by way of example only, can include a 1310 nanometer Fabry Perot (FP) Laser. Transmitter 318 thereby provides a second wavelength data transmission that is propagated through first cable 306 in a direction opposite than the first wavelength. This second wavelength data transmission is received by receiver 316 of subassembly 310 in second bi-directional communications module 302.

Thus, according to one aspect of the invention, the wavelengths of the signals traveling in opposite directions on a single fiber are of sufficiently different wavelengths to prevent the receivers from experiencing optical crosstalk due to internal reflection from the outgoing optical signals. No complex echo cancellation device is therefore required to remove the crosstalk. Because the presently disclosed devices have each port of the dual cable assembly attached to different transmitters and receivers, the technician who installs the optical cables onto the transceiver module must be careful to connect each cable to lasers having different wavelengths on either end of the cable.

The bi-directional communications modules 302, 304 also include a module casing 330, 332 configured to house or provide attachment points for other components included in the bi-directional communications modules 302, 304. The bi-directional communications modules 302, 304 can further include duplex connectors (not depicted) disposed on the module casing 330, 332 configured to mate with connectors (not depicted) affixed to cables 306, 308. Other conventional elements of bi-directional communications modules can be included in bi-directional communications modules 302, 304 as necessary or desired.

Referring now to FIG. 4, bi-directional communications module 400 can advantageously incorporate beam splitters 402, 404. With the exemplary transmitter wavelengths at approximately 1300 nm and 1550 nm, respectively, a preferred beam splitter would have a high reflectivity for either the 1300 nm or 1550 nm wavelength band and a high transmission for the other wavelength. Such a beam splitter would be similar in construction to the current product near-IR dielectric mirrors, model 5152, manufactured by New Focus. The New Focus mirrors have a high reflectivity between 700-900 nm and a high transmission for wavelengths larger than 1200 nm and are therefore unsuitable for the 1300 nm or 1550 nm wavelength bands, however.

The beam splitters 402, 404 are positioned between optical cables 406, 408, transmitters 410, 412, and receivers 414, 416, respectively. Thus, for example, a properly selected beam splitter 402 receives a signal from transmitter 410 containing a first signal along a first wavelength and passes it therethrough to cable 406. From an opposite direction, beam splitter 402 also receives a second signal via cable 406 containing data along the second wavelength. The beam splitter then reflects this second signal towards receiver 414. Thus, data in the first and second wavelengths is effectively routed to and from transmitter 410, receiver 414, and cable 406 by beam splitter 402. Of course, beam splitter 402 could also be configured to pass therethrough the signals containing the second wavelengths intended for receiver 414 and reflect the signals containing the first wavelengths received from transmitter 410. Beam splitter 404, transmitter 412, receiver 416, and cable 408 operate similarly, except transmitter 412 transmits signals along the second wavelength and receiver 416 receives signals along the first wavelength.

Of course, a number of other currently known and future developed devices for separating wavelengths are compatible with the present invention. These may include, by way of example only, a WDM fiber optic splitter manufactured by Thor Labs, part number WD202B.

Further, embodiments of the invention may be implemented in various ways. By way of example, the optical transceiver module of FIG. 4 can be implemented as a Small Form Factor Pluggable (“SFP”) bi-directional transceiver module. Such transceiver modules are configured for Gigabit Ethernet (“GigE”) and/or Fibre Channel (“FC”) and/or Sonet compliance. Moreover, these transceiver modules can operate over a wide range of temperatures. For example, some of these transceiver modules are effective over a temperature range of about 80° C., such as from about −10° C. about +70° C. Of course, such embodiments and associated operating parameters are exemplary only, and are not intended to limit the scope of the invention in any way. Other embodiments of the invention may be implemented in other dual cable compatible transceiver modules.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bi-directional communications module configured for propagating transmission and reception of optical data along dual optical cables, the module comprising:
a first transmitter configured for transmitting data on a first wavelength channel onto a first optical fiber;
a first receiver configured for receiving data on a second wavelength channel from the first optical fiber;
a second transmitter configured for transmitting data on the second wavelength channel on a second optical fiber; and
a second receiver configured for receiving data on the first wavelength channel from the second optical fiber.

2. The bi-directional communications module set forth in claim 1, wherein the first transmitter and the first receiver comprise a first bi-directional transceiver and the second transmitter and the second receiver comprise a second bi-directional transceiver.

3. The bi-directional communications module set forth in claim 2, wherein:
the first bi-directional transceiver further comprises a first beam splitter for reflecting only one of the first or second wavelength channels while permitting passage therethrough of the non-reflected wavelength channel; and
the second bi-directional transceiver further comprises a second beam splitter for reflecting only one of the first or second wavelength channels while permitting passage therethrough of the non-reflected wavelength channel.

4. The bi-directional communications module set forth in claim 1, wherein the module is compatible with small form factor pluggable (SFP) standards.

5. The bi-directional communications module set forth in claim 1, wherein the first receiver comprises a photodetector.

6. The bi-directional communications module set forth in claim 1, wherein the first transmitter comprises a laser selected from the group consisting of a distributed feedback laser and a Fabry Perot laser.

7. The bi-directional communications module set forth in claim 1, wherein the first wavelength channel and the second wavelength channel are of sufficiently different wavelengths to prevent the receivers from experiencing optical crosstalk due to internal reflection from the outgoing optical signals.

8. The bi-directional communications module set forth in claim 1, further comprising first and second duplex connectors that are configured to mate with connectors affixed to the first optical fiber and the second optical fiber.

9. A bi-directional communications module configured for propagating transmission and reception of optical data along dual optical cables, the module comprising:
a first bi-directional transceiver, the first bi-directional transceiver comprising:
a first transmitter configured for transmitting data on a first wavelength channel; and
a first receiver configured for receiving data on a second wavelength channel; and
a second bi-directional transceiver, the second bi-directional transceiver comprising:
a second transmitter configured for transmitting data on the second wavelength channel; and
a second receiver configured for receiving data on the first wavelength channel.

10. The bi-directional communications module set forth in claim 9, wherein:
the first bi-directional transceiver further comprises a first beam splitter for reflecting only one of the first or second wavelength channels while permitting passage therethrough of the non-reflected wavelength channel; and
the second bi-directional transceiver further comprises a second beam splitter for reflecting only one of the first or second wavelength channels while permitting passage therethrough of the non-reflected wavelength channel.

11. The bi-directional communications module set forth in claim 9, wherein the module is compatible with small form factor pluggable (SFP) standards.

12. The bi-directional communications module set forth in claim 9, wherein the first wavelength channel and the second wavelength channel are of sufficiently different wavelengths to prevent the receivers from experiencing optical crosstalk due to internal reflection from the outgoing optical signals.

13. An optical system for propagating transmission and reception of optical data along dual optical cables, the system comprising:
a first bi-directional communications module, comprising:
a first bi-directional transceiver, the first bi-directional transceiver comprising:
a first transmitter configured for transmitting data along a first wavelength channel; and
a first receiver configured for receiving data along a second wavelength channel; and
a second bi-directional transceiver, the second bi-directional transceiver comprising:
a second transmitter configured for transmitting data along the second wavelength channel;
a second receiver configured for receiving data along the first wavelength channel; and
a second bi-directional communications module, comprising:
a third bi-directional transceiver, the third bi-directional transceiver comprising:
a third transmitter configured for transmitting data along a first wavelength channel; and
a third receiver configured for receiving data along a second wavelength channel; and
a fourth bi-directional transceiver, the fourth bi-directional transceiver comprising:
a fourth transmitter configured for transmitting data along the second wavelength channel;
a fourth receiver configured for receiving data along the first wavelength channel; and
a first optical fiber in optical communication with each of the first transceiver and the fourth transceiver; and
a second optical fiber in optical communication with each of the second transceiver and the third transceiver.

14. The optical system set forth in claim 13, wherein:
the first bi-directional transceiver further comprises a first beam splitter for reflecting only one of the first or second wavelength channels while permitting passage therethrough of the non-reflected wavelength channel; and
the second bi-directional transceiver further comprises a second beam splitter for reflecting only one of the first or second wavelength channels while permitting passage therethrough of the non-reflected wavelength channel.

15. A method for propagating transmission and reception of optical data along dual optical cables, comprising:
at a first optical module, transmitting a first optical signal over a first wavelength channel down a first optical fiber in a first direction and transmitting a second optical signal over a second wavelength channel down a second optical fiber in the first direction; and
at a second optical module, transmitting a third optical signal over the second wavelength channel down the first optical fiber in a second direction and transmitting a fourth optical signal over the first wavelength channel down the second optical fiber in the second direction.

16. The method set forth in claim 15, wherein the first optical module and the second optical module are each compatible with small form factor pluggable (SFP) standards.

17. The method set forth in claim 15, wherein the first wavelength channel and the second wavelength channel are of sufficiently different wavelengths to prevent receivers in each optical module from experiencing optical crosstalk due to internal reflection from the outgoing optical signals.

18. A method for increasing data transmission capacity on an existing optical network comprising dual optical cables, the method comprising:
providing a legacy optical system that comprises first and second optical cables, each of the first and second optical cables comprising connectors at each terminus of the optical cables;
connecting a first bi-directional communications module on adjacent ends of each of the first and second optical cables and connecting a second bi-directional communications module to the opposing adjacent ends of each of the first and second optical cables, the first bi-directional communications module comprising:
connectors that are compatible with the connectors on the first and second optical cables;
a first transmitter configured for transmitting data on a first wavelength channel onto the first optical cable;
a first receiver configured for receiving data on a second wavelength channel from the first optical cable;
a second transmitter configured for transmitting data on the second wavelength channel on the second optical cable; and
a second receiver configured for receiving data on the first wavelength channel on the second optical cable.

19. The method set forth in claim 18, wherein the first transmitter and the first receiver comprise a first bi-directional transceiver and the second transmitter and the second receiver comprise a second bi-directional transceiver.

20. The method set forth in claim 18, wherein:
the first bi-directional transceiver further comprises a first beam splitter for reflecting only one of the first or second wavelength channels while permitting passage therethrough of the non-reflected wavelength channel; and
the second bi-directional transceiver further comprises a second beam splitter for reflecting only one of the first or second wavelength channels while permitting passage therethrough of the non-reflected wavelength channel.

21. A module as in claim 18, wherein the first bi-directional module is compatible with small form factor pluggable (SFP) standards.

22. The method set forth in claim 18, wherein the first wavelength channel and the second wavelength channel are of sufficiently different wavelengths to prevent the receivers from experiencing optical crosstalk due to internal reflection from the outgoing optical signals.
